(19) United States
(12) Patent Application Publication
(10) Pub. No.: US 2008/0303188 A1
(43) Pub. Date: Dec. 11, 2008

(54) Method and Device for the Preparation of a Template to make a Prototype for Jewelry

(76) Inventor: Shay Azani, Petach Tikva (IL)

Correspondence Address: UZI EZRA HAVOSHA & PARTNERS, HADAR-DAFNA HOUSE 39 SHAOUL HAMELECH STREET, TEL AVIV, 64928, IL

(21) Appl. No.: 12/127,034

(22) Filed: May 27, 2008

(30) Foreign Application Priority Data
Jun. 5, 2007 (IL) 183686

(51) Int. Cl. B28B 1/14

(52) U.S. Cl. 264/299

(57) ABSTRACT

A jewelry template made from chemical compounds to form a polyurethane substance that hardens in stages enabling the prototype to be inserted while the mixture is malleable and thereafter removed when the template is hard. A simple and efficient method of removing the prototype from the template.

### FIELD OF THE INVENTION

This invention is in the field of jewelry and more particularly making a template to simplify the manufacturer of jewelry.

### BACKGROUND of the INVENTION

Jewelry templates used in the trade today are complicated to produce, use many man hours to make and are therefore costly to produce. They use a polymer that requires high heat and high pressure to make the template harden with the prototype inside. Thereafter there is considerable difficulty and requiring a skilled person to extract the prototype from the template. This process in the art can 15 take a day to complete.

This invention comes to reduce the costs of template manufacturer by using less costly materials and by a method that requires less man hours to produce. The above mentioned process of making the template can be done in less than an hour without the use of a specially skilled person to do the work.

### SUMMARY of the INVENTION

It is to be understood that both the foregoing general description and the following detailed description present embodiments of the invention and are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, serve to explain the principles and operations of the invention.

This invention reveals a method of making templates for jewelry made in the following manner:

First an angos is attached to an item of jewelry (hereinafter called the “prototype”). The prototype is the example of the final product of jewelry to be produced and which is used to form the template. The angos is a small rod which, when removed, leaves a hole in the template through which the silver, or other molten material used to make the jewelry, is injected into the template.

Then the prototype with its attached angos is sprayed with a substance known in the art as a release agent that prevents the prototype from sticking to the polyurethane mold or template. The release agent is a standard substance used in the art usually being an alcohol based substance.

The next stage is to spray the tray used to hold the template with the release agent.

Then the polyurethane template is made by mixing two chemicals to create a polymer urethane rubber-like substance which when mixed and left to cure, produces the desired template. Until it fully cures it goes through stages of hardness thereby enabling the user to use those first few minutes to mold the template to the required shape.

The bottom portion of the polyurethane template is poured into the said tray to a depth of about three quarters of the depth of the tray and is left to harden.

The prototype with the angos attached is then placed into the template to a depth of about three quarters of the depth of the prototype. The angos is placed to touch the outer edge of the said tray.

The release agent is then sprayed onto the remaining quarter exposed part of the prototype and angos and onto the inner side of the top portion of the template.

More polyurethane chemical is prepared and laid on top of the prototype until the said tray is filled with the chemical. The polyurethane template is left to harden. After the required degree of hardness is reached the top layer of the template is separated from the bottom layer. The prototype and its angos are then removed from the template. This is made easier because the release agent was used to prevent the polyurethane chemical from sticking to the prototype and the top layer of the template sticking to the bottom layer.

The two parts of hardened polymer form the desired template. To use the template the two parts are held together by a band or other convenient means. The hollow form of the prototype will be inside the template with a small hole leading to the outside wall to enable the entry of the molten metal of the jewelry. The template can be re-used many times.

### BRIEF DESCRIPTION OF THE DRAWINGS

The accompanying drawings, which are incorporated in and form a part of this specification, illustrate embodiments of the invention and together with the description, serve to explain by way of example only, the principles of the invention:

FIG. 1 is a schematic depiction of a prototype ring with an angos attached.

FIG. 2 is a schematic depiction of a template tray being sprayed.

FIG. 3 is a schematic depiction of the polyurethane mixture in the template tray.

FIG. 4 is a schematic depiction of the prototype having been placed in the polyurethane mixture.

FIG. 5 is a schematic depiction of the two layers of the template bound together ready to receive molten jewelry metal via the angos hole.

### DETAILED DESCRIPTION OF THE PREFERRED EMBODIMENTS

As will be appreciated the present invention is capable of other and different embodiments than those discussed above and described in more detail below, and its several 5 details are capable of modifications in various aspects, all without departing from the spirit of the invention.

Accordingly, the drawings and description of the embodiments set forth below are to be regarded as illustrative in nature and not restrictive.

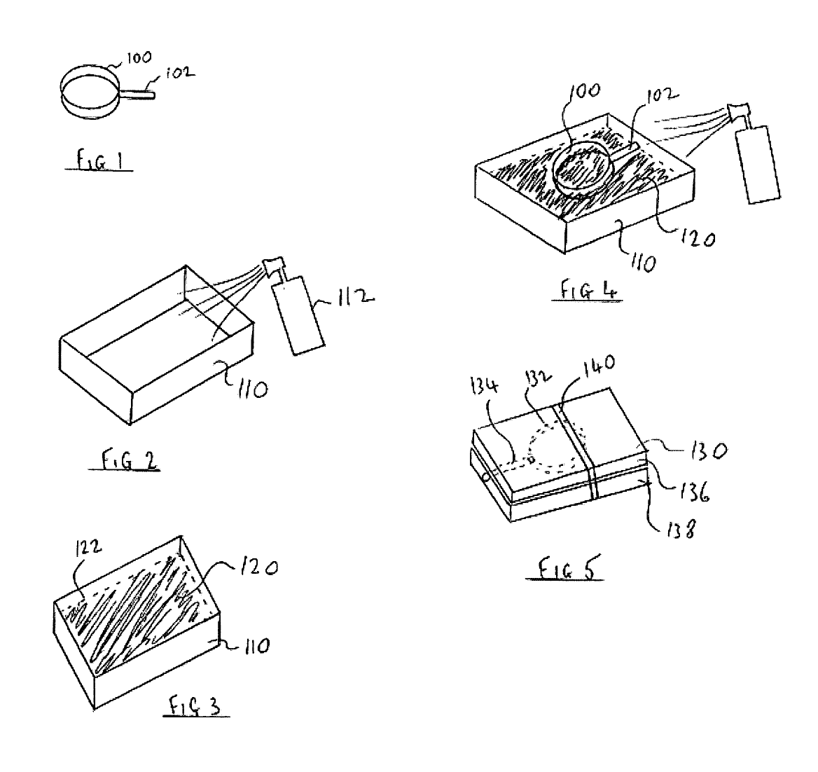

FIG. 1 shows a prototype ring 100 that will be the subject of the template where it is desired to produce more than one ring identical in size and shape to the prototype ring 100. Attached, detachably, to the ring 100 is a rod called an angos 102 that will create a cylindrical hollow passage in the template for the purpose of letting into the template the molten metal of the jewelry.

FIG. 2 shows a tray 110 that is used to hold the fresh polymer mixture until it hardens. To prevent the said mixture from sticking to the ring FIG. 1 100 and from sticking to the tray 110 they are both sprayed with release agent 112.

FIG. 3 shows the tray 110 with the mixture 120 used to make the polyurethane foam placed in the tray 110 to a level of about three quarters of the depth of the tray 110 as shown by line 122.

FIG. 4 shows the ring 100 placed in the still malleable polyurethane 120 leaving about one quarter of the ring exposed.

Attached to the ring 100 is the angos 102 whose end is placed against a wall of the tray 110. This angos 102 will 5 leave a passage when removed from the template through which the molten silver or other material of the jewelry is injected.

The ring 100, the angos 102, and the top surface of the hardened polyurethane mixture 120 are all sprayed with the release agent spray 112 to prevent the upper layer of polyurethane from sticking to the lower layer and the prototype.

FIG. 5 shows the template 130 having been removed from the tray FIG. 4 110 and the prototype and angos 134 having been 15 removed leaving the hollow impression of the prototype 132 and connecting passage 134. The upper 136 and lower layer 138 of the template 130 are bound together with a removable band 140.

The template is now ready for use, that is to say, to inject 20 molten silver into passage 134 to fill the hollow ring shape 132. When the molten silver is cool the band 140 is released and the new ring removed leaving the template ready to be used again.

What is claimed:

1. A method and device to make a jewelry template comprising,
a. a mold to hold the polyurethane template in its liquid state until the polyurethane hardens,
b. a polyurethane compound that is liquid when first mixed and becoming harder as time passes,
c. placing a prototype article partially into the said hardening polyurethane with an angos touching the side wall of the said mold,
d. covering the protruding portion of the said prototype article with an upper layer of the said polyurethane compound,
e. removing the said template and said angos after the hardening of the said upper layer,
f. a removable band to hold the said upper and said lower layer, and
g. spraying with a releasing agent the parts involved in manufacture of the said jewelry template where it is required for the said parts not to adhere one to the other,
whereby a template is thereby made to produce jewelry from molten substances.

2. A method and device to make a jewelry template comprising
a. a lower layer of a liquid material that hardens with time,
b. a prototype removably placed partially into the said lower layer,
c. an upper layer of the said material placed over the said lower layer,
d. a means for liquid jewelry substance to reach the hollow shape left by the removed said prototype, whereby the resulting hollow form is a re-usable template for making jewelry.
